(19) United States
(12) Patent Application Publication
(10) Pub. No.: US 2003/0164827 A1
(43) Pub. Date: Sep. 4, 2003

(54) System and method for displaying search results in a three-dimensional virtual environment

(76) Inventors: Asaf Gottesman, Kfar Shmaryaho (IL); Udi Bobrovsky, Kiryat Netafim (IL)

Correspondence Address: Eitan, Pearl, Latzer & Cohen Zedek, LLP., Suite 1001, 10 Rockefeller Plaza, New York, NY, 10020, US

(21) Appl. No.: 10/356,739

(22) Filed: Feb. 3, 2003

Related U.S. Application Data
(63) Continuation-in-part of application No. 09/859,376, filed on May 18, 2001.

(51) Int. Cl. G06T 15/00

(52) U.S. Cl. 345/419

(57) ABSTRACT

A system and method for presenting search and/or data query results within a virtual three-dimensional environment. A data container containing a parameter representing at least a portion of the content derived from a database search result may be rendered within the environment, thereby producing a two dimensional prospective view from a view point within the environment. The viewpoint may be moved along a selected or predefined path and the data container's parameters may be updated in relation to the position of the viewpoint.

### RELATED PATENT APPLICATIONS

This application is a continuation-in-part of U.S. patent application Ser. No. 09/859,376, filed May 18, 2001, the entire specification of which is herein incorporated by reference.

### FIELD OF THE INVENTION

The present invention relates to the field of virtual presentation systems. More specifically, the present invention relates to the presentation of content located or identified with the use of a search engine or other data querying tool.

### BACKGROUND OF THE INVENTION

Few will argue that the Internet has revolutionized the means and the formats by which human beings communicate today. Specifically, a series of Internet software applications have brought color, site, sound, and some would even say life to content published on the Internet, collectively referred to as the World Wide Web. The World Wide Web started with a relatively simple interactive search and presentation application called MOSAIC—the world's first web browser. MOSAIC was developed by academics in order to facilitate the sharing of research data located on computer systems at universities around the world. Soon after its development, however, wide spread commercialization of MOSAIC began.

Since MOSAIC's introduction, numerous other web browsers and related software applications have been developed. Whereas MOSIAC presented static content in a two dimensional format, more recent World Wide software applications, such as Flash™ and Real Player™, are capable of accessing and presenting dynamic content such as streaming audio/video, and various combinations of other multimedia, including “active containers” which are described detail in Applicants' previous co-pending application, U.S. patent application Ser. No. 09/859,376, which is incorporated herein by reference. Certain applications have attempted to simulate three-dimensional environments over the Internet. For example, the web site “www.worlds.com” allows a visitor to download a software application, commonly referred to as a plug-in, which works in conjunction with the visitor's web browser to simulate a three dimensional environment on the visitors screen. The parameters of the environment (walls, floor, and other containers within the 3-D space) are produced by the site's computer system, and several visitors to the site may share and interact within a common environment.

Visitors to web sites providing three-dimensional environments, such as “www.worlds.com”, are usually assigned a virtual representative or agent, commonly referred to as an avatar. The visitor's view of the environment is from the perspective of the avatar, and the visitor navigates the three dimensional environment by directing their avatar to move within the virtual 3-D space. The visitor's view of the environment changes in relation to the avatar's change in perspective. Thus, in order for a visitor to change their view of the environment, they must direct their avatar to move.

However, web sites providing three-dimensional environments today only display content that is predefined by the web site operators and users. Thus, the scope of the content that is displayed in web sites providing three-dimensional environments is quite limited.

A search engine is a well know term used to describe a set of programs that include:

A spider (also called a “crawler” or a “bot”) that goes to pages, or representative pages on web sites that want to be searchable, and reads them, using hypertext links on each page, to discover and read a site's other pages;

A program that creates a huge index (sometimes called a “catalog”) from the pages that have been read, and a respective program that receives search requests, compares such requests to the entries in the index, and returns results to the user.

An alternative to using a spider or an index is to explore a structured directory of topics. A number of web sites offer both the search engine and directory approaches to finding information.

Search engines such as Google, Yahoo (which uses Google), AltaVista, and Lycos index the content of a portion of the World Wide Web and provide search results in a format that can run for pages—and which may consequently overwhelm a user. Furthermore, present day search engines provide or present search results in a static two-dimensional format, requiring the user to manually scan the search results.

### SUMMARY OF THE INVENTION

According to some embodiments of the present invention, a virtual three-dimensional environment may be generated using data produced as a result of either a search engine or database query. As part of the present invention, a system and a method of presenting content may present search or query results in a three-dimensional prospective view or format. Each search result may be represented by an object within the environment, wherein each object may be a data container.

A data container may contain one or more parameters, where each of the parameters may be correlated with one or more portions of data or content derived from a search result (hereinafter comprising both search engine results and results from other database queries). A data container may be rendered in a virtual three-dimensional environment such that the appearance of the container within the environment is correlated to the search result with which it is associated, or which it represents, such that a viewer may derive insight or information about a specific search result by viewing its associated data container.

A user of the present invention may view one or more data containers from the perspective viewpoint of a virtual agent or avatar traveling along a path through the three-dimensional environment. The data container's parameters may be updated as a function of the agent's position within the environment and the database search result. The container's position may also change to create the perception that the container is either traveling towards or away from the viewer's agent. A container may either have persistence, such as a portion of the environment's background, or may be transient, moving in and out of the environment.

One or more of a container's parameters may be an associated function, such that when a user interacts with the container, the associated function or functions are initiated or executed. One associated function may be the downloading (e.g. via a hyperlink) or accessing of data related to the search result associated with the specific data container. A user may interact with a container through a variety of input methods. A container's associated function, just as any other container parameter, may also be updated and changed as a function of time and as a function of the agent's position within the environment.

### BRIEF DESCRIPTION OF THE DRAWINGS

The subject matter regarded as the invention is particularly pointed out and distinctly claimed in the concluding portion of the specification. The invention, however, both as to organization and method of operation, together with containers, features, and advantages thereof, may best be understood by reference to the following detailed description when read with the accompanying drawings in which:

FIG. 1A is a diagram showing a computer screen with one possible virtual three-dimensional environment produced in accordance with some embodiments of the present invention;

FIG. 1B is a diagram showing a computer screen with one possible input screen for a search engine or database query according some embodiments of the present invention;

FIG. 1C is a conceptual diagram showing a virtual agent traveling through a virtual environment in which search engine results are presented as objects in a prospective three-dimensional format according to some embodiments of the present invention;

FIG. 2A is a diagram showing an example of display parameters of a data container changing as a function of a virtual agent's position relative to the container;

FIG. 2B is a diagram showing an example of the points at which display parameters of a data container may change as a virtual agent travels along a predefined path within a virtual environment;

FIG. 3 is a diagram showing a partial list of parameters that a data container may contain, according to some embodiments of the present invention;

FIG. 4 is a diagram showing an example of a system for implementing a search and presentation according to some embodiments of the present invention; and

FIG. 5 is a flow diagram showing the steps of a method of performing a search and producing a presentation of search results according to some processes of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the present invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

According to some embodiments of the present invention, a virtual three-dimensional environment may be generated using data produced as a result of either a search engine or database query, hereinafter also referred to as “search engine results” and/or “data query results”, which are interchangeable. As part of the present invention, a system and a method of presenting content may present search or query results (hereinafter referred to as “search results”) in a three-dimensional prospective view or format. Each search result may be represented by an object within the environment, wherein each object may be a data container.

A data container may contain one or more parameters, where each of the one or more parameters may be correlated with one or more portions of data or content derived from a search result. A data container may be rendered in a virtual three-dimensional environment such that the appearance of the container within the environment is correlated to the search result with which it is associated, or which it represents, such that a viewer may derive at least some insight or information about a specific search result by viewing its associated data container.

A user of the present invention may view one or more data containers from the perspective viewpoint of a virtual agent or avatar traveling along a path through the three-dimensional environment. The data container's parameters may be updated as a function of the agent's position within the environment and the database search result. The container's position may also change to create the perception that the container is either traveling towards or away from the viewer's agent. A container may either have persistence, such as a portion of the environment's background, or may be transient, moving in and out of the environment.

One or more of a container's parameters may be an associated function, such that when a user interacts with the container, the associated function or functions are initiated or executed. One associated function may be the downloading (e.g. via a hyperlink) or accessing of data related to the search result associated with the specific data container. A user may interact with a container through a variety of input methods. A container's associated function, just as any other container parameter, may also be updated and changed as a function of time and as a function of the agent's position within the environment.

As part of the present invention, a three-dimensional environment, which may include a data container, may be rendered by a rendering module. A data container may possess no inherent or immutable visible characteristics, but rather may contain one or more parameters representing at least some portion of content of search or query results to be presented. The data container, along with its parameters, may be rendered in a virtual or prospective three-dimensional environment and assigned a position within the environment. Each of one or more data containers may also contain one or more display parameters that may include such characteristics as position, size, shape, color, texture, surface appearance or covering, and movement. A container may have a fixed position or may move in and out of the environment. A container may have an associated message or picture that is mapped onto the surface of the container. In the event a search or query is performed on an image data base(s), the results of the search, which are images, may be mapped onto the surface of one or more containers within the environment.

The viewer's view of the environment may be produced by a view production module, which may produce a view from the perspective of a virtual agent traveling through the environment. As the virtual agent travels through the environment, the viewer's perspective of the environment and of containers contained therein may change accordingly. Furthermore, display parameters and parameters with associated functions of one or more of the data containers within the environment may change or be updated by a parameter update module. The update module may update the parameters and/or associated functions in relation to a change in the viewer's perspective or as a function of the virtual agent's position in the environment or as a function of time. That is, associated functions and display parameters such as shape, color or mapped images/pictures, of one or more of the containers, may change as the virtual agent's position in the environment changes and as a function of time. A container's associated functions and display parameters may be updated with pre-selected parameters stored on a database, or may change according to input received over a distributed data network. A parameter of a container may be updated with the results of a database or Internet search or query.

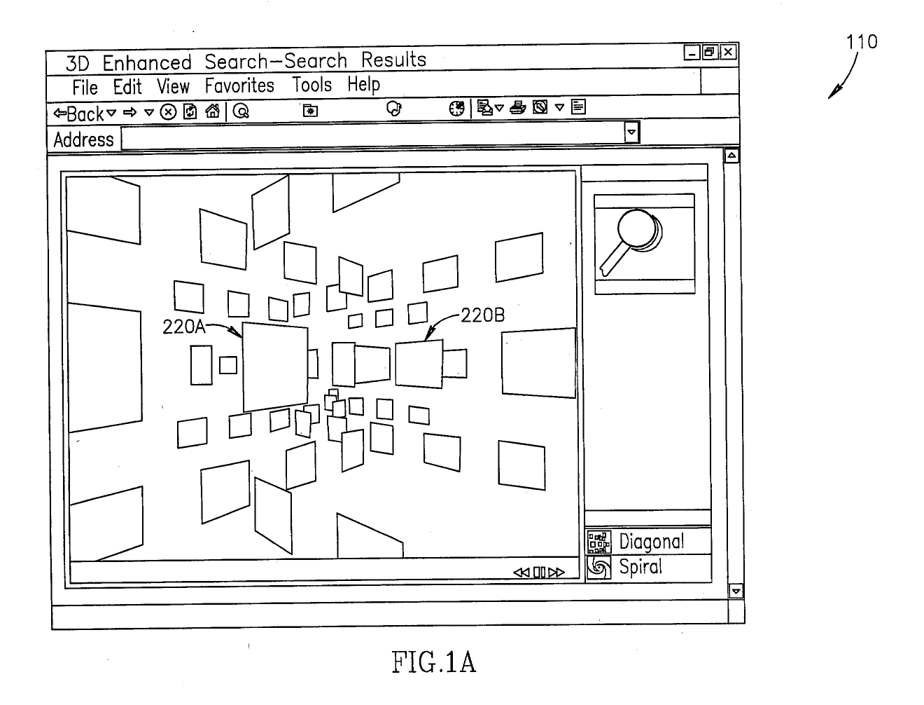

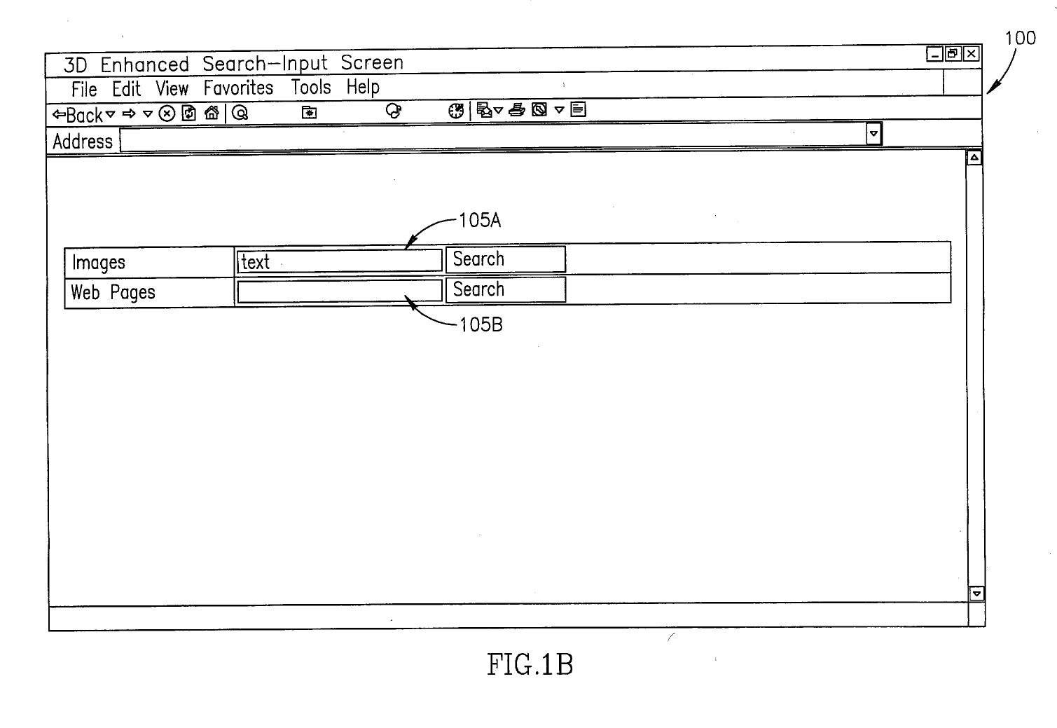

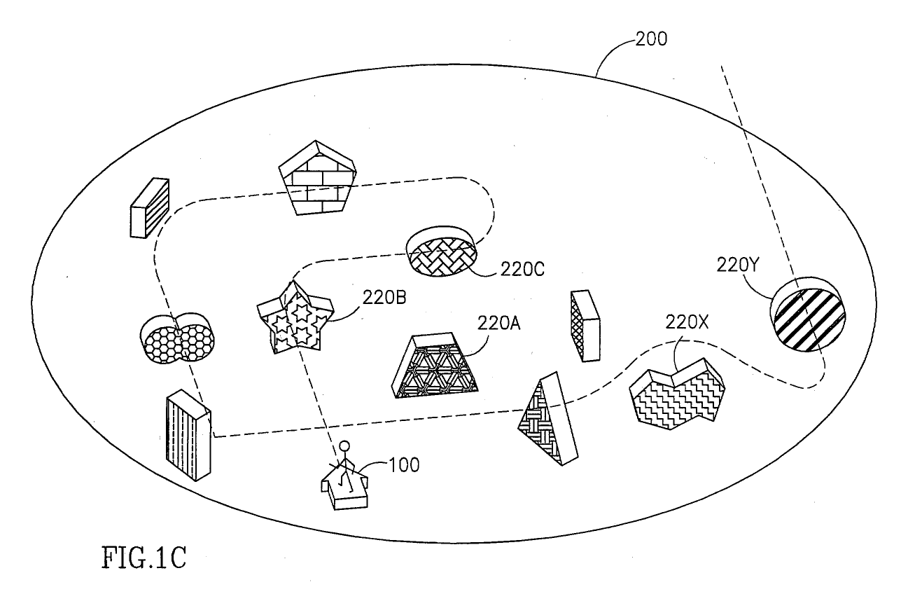

Turning now to FIG. 1C, there is shown a diagram depicting a computer screen according to some embodiment of the present invention where search engine results may be presented as objects in a virtual three-dimensional environment 200. Since a computer screen is inherently two-dimensional, the virtual three-dimensional environment may be rendered in a two-dimensional perspective format intended to produce a three-dimensional effect. In some embodiments of the present invention, the two dimensional environment may be rendered continuously from a moving vantage point so as to create the impression of movement within the environment. As part of the present invention the perspective view may change in accordance with the viewpoint or position of a virtual agent 100 (FIG. 1C) passing through the virtual environment 200. Thus, the data containers 220 may appear as if they are either moving towards or away from a viewer watching the screen of FIG. 1A.

The objects in the environment 200 may be data containers, 220A and 220B etc., having one or more parameters including display parameters and associated functions. A data container's parameters may contain at least portions of information relating to a result of a search or query. An associated function of a data container may be a link back to the source of a given search result (e.g. link back to a URL found as a result of an internet search engine query).

FIG. 1B shows an example of an input screen for a search engine or database query according to some embodiments of the present invention. A viewer may enter search parameters through a text area or field 105. FIG. 1B shows an input screen which is formed within a web browser. However, one of ordinary skill in the art should understand that such an input screen may also be a stand-alone computer application or a plug-in within a variety of host computer applications, not just within a browser.

Search terms entered into an input screen, such as the one shown in FIG. 1B, may be used as search parameters of a search or query of one or more databases. The search parameters may be used to query one or more remote or local database(s), or may be passed along to one or more search engines which may then perform a search or query for content correlated to the search terms or parameters. In the event that the search or query finds records or other data correlated to the search terms or parameters, the results may be transmitted to a user's computer into which the search terms were entered, or to another computer device selected by the user. Results of the search or query may then be associated or placed within data containers 220 and displayed in a virtual three-dimensional environment 200 according to the present invention.

Turning now to FIG. 1C, there is shown a conceptual diagram of a possible virtual three-dimensional environment 200 produced in accordance with some embodiments of the present invention. The three-dimensional environment 200 may be populated with one or more data containers 220, each of which may contain one or more parameters representative of at least some portion of a search result. A viewer may see the environment 200, along with the data containers 220 therein as a two-dimensional perspective view from the viewpoint of a virtual agent 100. Each data container 220 may contain portions of a result of a search or a query of a database. For example, a container may contain data representative of an image retrieved from an image database, a link or URL to a web server where an image is stored, a description of a search result, etc. The virtual agent 100 may follow a predefined path 120 within the environment, which may take the agent around and/or through data containers 220 in the environment 200. As the virtual agent 100 travels through the environment 200, the viewer's perspective view may change along with the agent's 100 position and viewpoint within the environment. A rendering or view production module, according to some embodiments of the present invention, may render two-dimensional perspective Views of the environment 200 as the virtual agent 100 passes through the virtual environment 200.

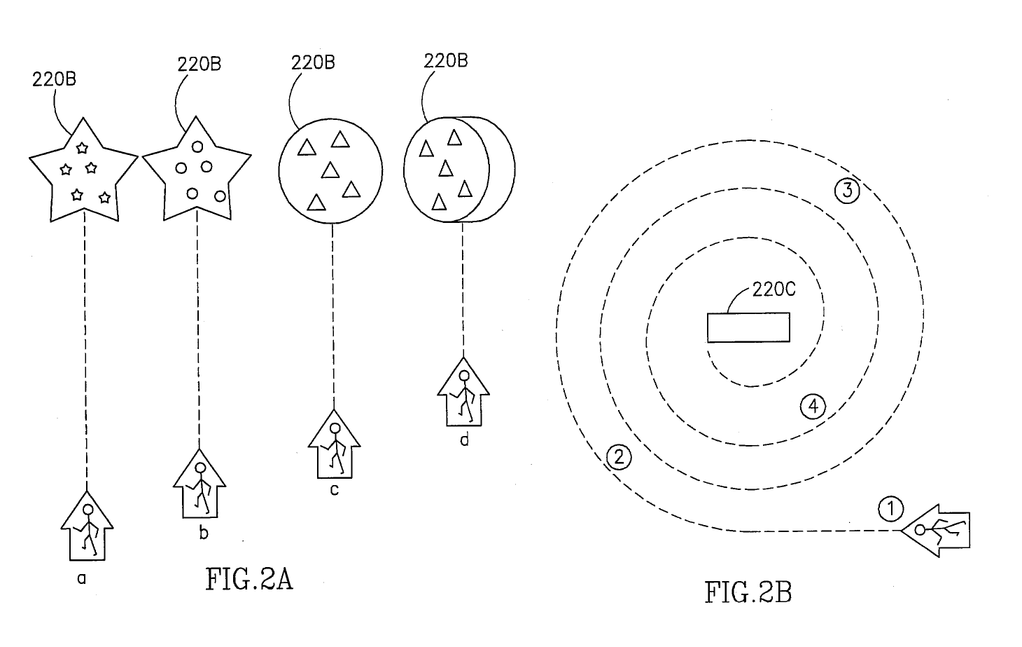

Turning now to FIG. 2A, there is shown a series of diagrams depicting the approach of a virtual agent towards a data container 220B. In FIG. 2Aa, the agent is a certain distance from the container 220B and the container's display parameters may cause the data container 220B to appear, for example, as a star shaped polygon having star shapes on its surface. In FIG. 2Ab, the virtual agent's position is closer to the data container 220B and display parameters may be changed or updated by a parameter update module in order to make the data container 220B appear, for example, as a star shaped polygon having circle shapes on its surface. In FIG. 2Ac, the virtual agent's position is even closer to the data container 220B and the display parameters may be updated once more such that the data container 220B appears as a circle with triangle shapes on its surface. FIG. 2Ad shows the virtual agent at yet another position and the data container's display parameters again updated to cause the container to be rendered as a rotating circle.

Turning now to FIG. 2B, there is shown a diagram depicting a virtual agent traveling a path around a data container 220C. The path is shown by a dashed line, and points along the path where a parameter of the data container 220C may be updated are marked by a number within a circle. At each of the marked points, a parameter update module may update one or more of the data container's 220B parameters. A container's parameter may be updated with another portion of a single search result or may be updated with a portion of data from a second search result.

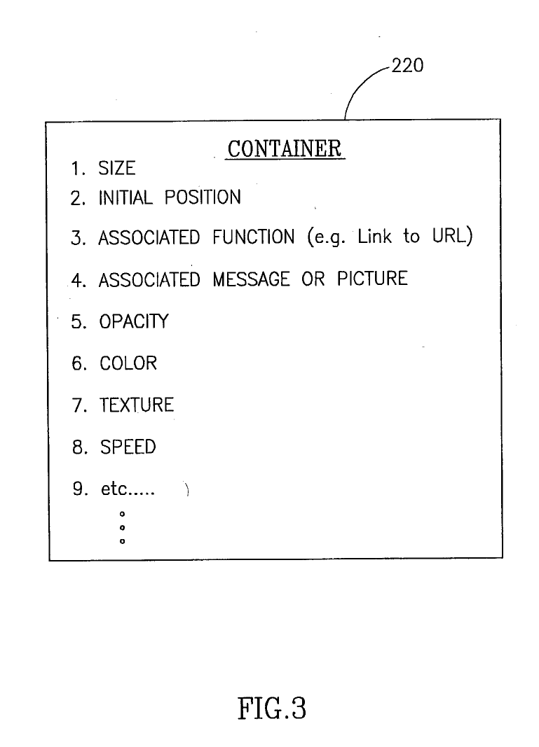

Turning now to FIG. 3, there is shown a block diagram depicting a data container 220 and various parameters that it may contain. The data container may initially be in the form of a generic data array or structure (like a template for data storage according to a particular format) that may be located within a database. Such a container may contain fields for receiving data according to various relevant categories or parameters. A typical data container may have one or more parameters including size, initial position, at least one associated function (such as a link to a URL) and one or a series of display parameters (such as position, size, shape, color, texture, opacity, speed, mapped pictures/images or other messages, and movement etc.). An associated function may be executed or initiated when a viewer interacts with the data container 220 to which the function is associated. Interaction with a data container may occur through the use of a mouse pointer, a keyboard, or any other input device. For example, when a viewer clicks with his or her mouse on a container shown within FIG. 1C, a link to a search result associated with the container may be executed and the search result may be downloaded to the viewer's computer. An associated function may also be executed when the virtual agent 100 reaches a specific point along the predefined path. An example of an associated function is a hypertext link or URL.

A data container 220 may be rendered within the environment in accordance with its display parameters. Display parameters may define such characteristics as position, size, shape, color, texture, mapped pictures/images or other messages, and movement etc. Movement parameters may include direction, speed, direction of rotation, and rotational velocity etc. A data container 220 may have a fixed position or may move within the environment. A data container 220 having no display parameters may appear transparent within the environment.

As the virtual agent 100 travels along the path 120, one or more of the containers' associated functions and display parameters may be updated. For example, while the virtual agent is at point 220a (FIG. 1C), data container 220C may have the shape of a triangle and be covered by a first bit map. As the virtual agent approaches point 220b, the display parameters of data container 220C may be updated such that data container 220C is re-rendered as a square covered by a second bitmap. The new or updated parameters may be associated with either the same or with a different search result.

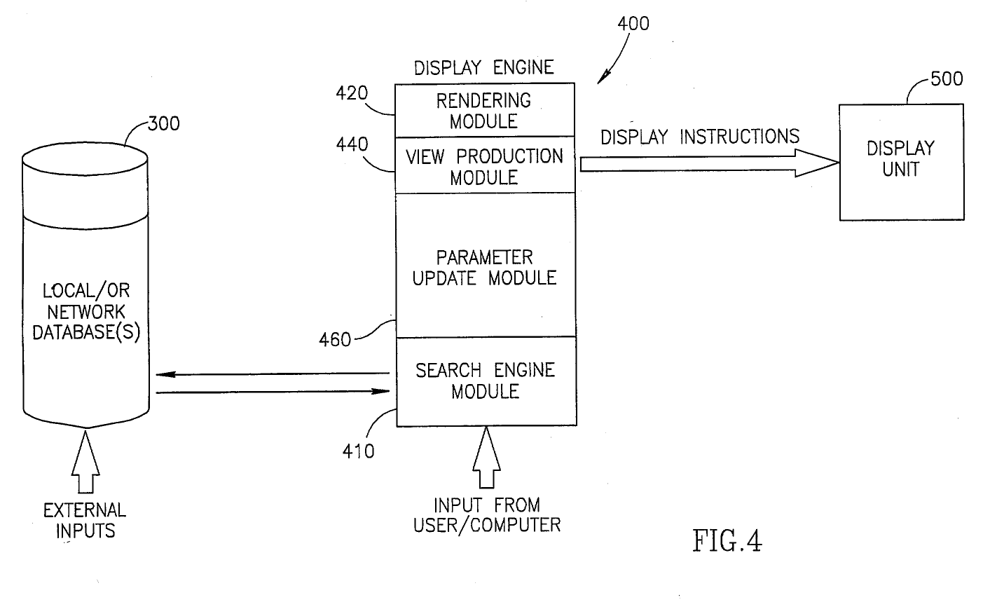

Turning now to FIG. 4, there is shown a system according some embodiments of the present invention for displaying database or Internet search/query results as objects in a virtual three-dimensional environment. As part of the embodiment shown in FIG. 4, a display engine 400 may receive the data comprising a data container 220 from a storage unit 300. Storage unit 300 may either reside on the same computer as the display engine 400 or may be connected to the display engine 400 through a network connection. The display engine 400 may include a search engine module 410, a rendering module 420, a view production module 440, and a display parameter update module 460.

The search engine module 410 may receive one or more search inputs or terms from a user and may transfer the search terms or parameters to at least one database 300, with a request for the database to conduct a search or query of its records for possible and/or probable matches to the search term(s). The one or more databases 300 may either be a database associate with the user's computer or may be a search engine residing on one or more servers, either on the Internet or over another distributed network.

Upon receiving results from the one or more databases 300, the search engine module may provide the results to a parameter update module 460 which may assign at least some portion of each search result to a generic data container 220. That is, the parameter update module 460 may assign or match at least some portion of each search result as at least one parameter (e.g. display parameter or associated function) to one or more data containers 220. These data containers are subsequently rendered in a virtual environment according to some embodiments of the present invention. For example, if the search results are an ordered list of files, where each file contains an image and where each file was produced in a different year, the search engine module 410 may request that the parameter update module 460 update at least one data container for each result, such that each container is provided with an image, where each image is mapped as a display parameter on at least one data container. Additionally, the update module 460 may associate a specific shape with the year each image was produced and may assign a shape to a data container corresponding to the year the image on that container was produced. The parameter update module 460 may also assign a size and/or speed of movement value corresponding to the relevance of the score of each search result, where more relevant results having higher correlation with the search parameters are assigned larger sizes and/or slower movement parameters.

In the simplest of all examples, the search results may be URL links resulting from an Internet search engine query, and the parameter update module 460 may assign a thumbnail or snap shot of the web page associated with each URL as a display parameter to one or more data containers 220. Data containers' parameters may be updated with one or more search results. More specifically, an image associated with one or more search results may be mapped as a surface picture or a pattern onto a data container, and a link to data associated with the search result may be made the data container's associated function.

The rendering module 420 may render the virtual three-dimensional environment 200, including text, graphic, audio and/or video elements in the rendered background, as well as the data containers 220. Rendering of three-dimensional environments is well known in the art. Numerous commercially available software products are available and may be used as part of the present invention. In general, a rendering module operates in conjunction with a computer processor to compile a data set or array, or set of arrays of data, in a computer memory.

A view production module 440, may generate a two-dimensional image representing a prospective view of the environment 200 from the viewpoint of the virtual agent 100. The view production module 440 may use the data set compiled by the search engine module 410, the parameter update module 460 and by the rendering module, 420 to generate an image for each point along the path 120. Conversion or mapping of a data set representing a virtual three-dimensional environment into a two-dimensional image is well known in the art. Commercially available software such as MatLab, 3DMAX or even the well known video game Doom are examples of software having view production modules which may be used as part of the present invention.

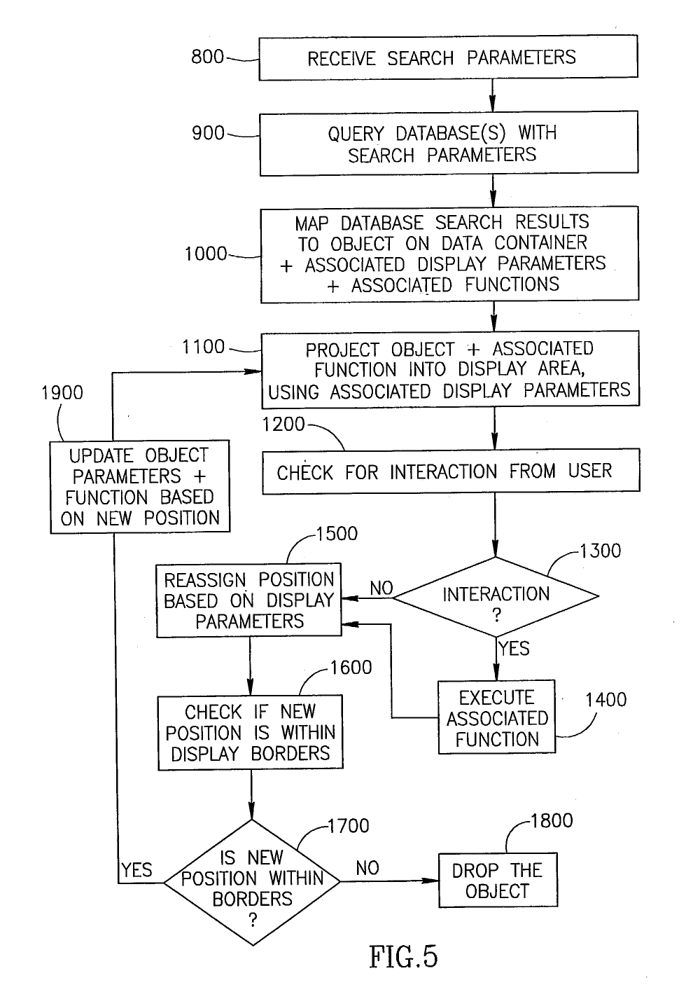

Turning now to FIG. 5, there is shown a flow diagram with steps that may be performed to produce a virtual three-dimensional environment 200 according to some embodiments of the present invention. In step 800, a search engine module 410 may receive one or more search parameters or terms. As part of step 900, the search engine module 410 may search or query at least one database, remote or local, and may receive search results. In Step 1000, the display engine 400 may receive a data container 220 along with its associated function and associated parameter fields. The display engine 400 may also receive result data following a data request (such as a search request) from search engine module 410. The parameter update module 460 may then map at least one search result or aspect of a search result to at least one data container, thereby providing the container with data for at least one of its associated functions and parameters. As part of Step 1100, the container may be rendered and projected into a virtual three-dimensional environment, using associated display parameters, by rendering module 420. The term “projected” generally means adding to the data set representing the environment 200. Interaction by a viewer with a data container 220 may be checked for as part of Step 1200, and if an interaction occurs, the container's associated function may be executed as part of Step 1400. Since the virtual agent 100 of the present invention may travel along a predefined path, not requiring the viewer to use an input device to control its movement, one or more computer pointing devices, such as a mouse, are free to allow a viewer to point to and/or click on a data container 220. Other input devices such a. light pen or a keyboard may also be used to interact with a data container 220.

As part of step 1500, a new position is assigned to the data container 220 within the environment. The position is assigned based on parameters of the container 220, and the new position is checked as part of steps 1600 and 1700, with relation to the environment's display borders. As part of step 1900, the parameter update module 460 may update or change the display parameters and associated functions of a data container 220 in response to a change in the position of the container 220 or in response to a change in the viewpoint of the virtual agent 100.

A change in a container's display parameters may result in the rendering module 420 re-rendering the container 220 in accordance with the new parameters. A further result of updating one or more parameters is that the view production module 440 may generate an image showing a container 220 in accordance with the new parameters, representing a prospective view of the environment 200 from the viewpoint of the virtual agent 100, thus producing a sudden morphing effect. If a container 220 has parameters defining its movement within the environment 200, during Step 1500, the container's position may be reassigned. As part of Step 1900, a container's display parameters may be updated, and returning to Step 1100, the container 220, with any possible changes to its position and parameters, may once again be projected into the environment.

The parameter update module 460 may receive new parameters from search engine module 410. The search engine module 410 may receive additional search results, more than the results that are displayed at any one time in an environment according to some embodiments of the present invention. Additionally, the search engine module may dynamically receive new search parameters from a database 300. Thus, new search results received from a database 300 may be placed within the environment 200 by updating an existing data container 220 with the environment with new parameters associated with the new search result.

While certain features of the invention have been illustrated and described herein, many modifications, substitutions, changes, and equivalents will now occur to those skilled in the art. It is, therefore, to be understood that is the appended claims are intended to cover all such modifications and changes as fall within the true spirit of the invention.

What is claimed is:

1. A system for presenting search engine results in a virtual three-dimensional environment, said system comprised of:
an environment rendering module to receive a data container adapted to contain at least one content display parameter representing at least a portion of the search engine results, said module adapted to render said container as a function of the content display parameter;
a search engine module adapted to receive at least one search parameter, and to map at least one search result to the content display parameter; and
a view production module to produce a two dimensional image correlated to a prospective view of the virtual environment from a view point within the virtual environment;

2. The system according to claim 1, wherein said search engine module is adapted to transfer said search input parameters to at least one database.

3. The system according to claim 1, wherein said data container is adapted to contain at least one result of a search query.

4. The system according to claim 3, wherein said content display parameter defines at least one display feature of said data container selected from the group consisting of location, size, shape, texture, skin cover, opacity and movement.

5. The system according to claim 4, wherein the movement parameter is selected from the group consisting of direction, speed, direction of rotation, and rotational velocity.

6. The system according to claim 1, further comprising a parameter update module adapted to update the content display parameter.

7. The system according to claim 6, wherein said parameter update module is adapted to receive content display parameters from said search engine module.

8. The system according to claim 6, wherein said parameter update module is adapted to update the content display parameter as a function of said view point's position.

9. The system according to claim 1, wherein said view production module is adapted to use a data set compiled by said search engine module.

10. The system according to claim 1, wherein said viewpoint follows a predefined path within the environment.

11. A method for presenting data query results in a virtual environment comprising:
providing a data container to represent the data results;
receiving at least one data query result and applying at least a portion of said data query result to said data container; and
rendering a two dimensional image of the data container correlated to at least one prospective view of the data query result in the environment from at least one viewpoint within the environment.

12. The method according to claim 11, wherein said content display parameter defines at least one display feature of said data container selected from the group consisting of location, size, shape, texture, skin cover, opacity and movement.

13. The method according to claim 12, wherein the movement parameter is selected from the group consisting of direction, speed, direction of rotation, and rotational velocity.

14. The method according to claim 11, further comprising updating the content display parameter.

15. The method according to claim 14, wherein updating the content display parameter further comprises receiving at least one additional data query parameter, and updating the content parameter as a function of said additional data query parameter.

16. The method according to claim 15, wherein updating the content display parameter further comprises updating the content parameter as a function of said viewpoint's position.

17. The method according to claim 11, wherein said producing a two dimensional image further comprises using a data set compiled by a search engine module.

18. The method according to claim 16, wherein said updating the content display parameter further comprises following a predefined path within the environment.
